(19) United States
(12) Patent Application Publication
(10) Pub. No.: US 2005/0172275 A1
(43) Pub. Date: Aug. 4, 2005

(54) Execution of instructions in an automation system

(76) Inventor: Thilo Opatemy, Numberg (DE)

Correspondence Address: SIEMENS CORPORATION;INTELLECTUAL PROPERTY DEPT., 170 WOOD AVENUE SOUTH, ISELIN, NJ, 08830, US

(21) Appl. No.: 10/768,732

(22) Filed: Jan. 29, 2004

(51) Int. Cl. G06F 9/45

(52) U.S. Cl. 717/140

(57) ABSTRACT

The invention relates to a method and a system for creating instructions in an automation system which is used especially to complete a control task or to regulate a process. The creation of the instructions is simplified by defining operands, control values and instruction types associated with the operands, in the instructions, said instructions being executed by a firmware of the automation system. The instructions can be parameterized by a user by input means of a programming device, and programming device automatically specifies an execution moment (SKB, SKE) and an application frequency of the instructions according to the operand and the type of instruction, and associates them with the instructions.

The invention relates to a method and a system for creating instructions in an automation system which is used especially to complete a control task or to regulate a process.

So that an automation system can be adapted by users to complete a task, a modern automation system consists essentially of software. This software is created on a programming device and is loaded onto the automation system. The programming device is not required for the actual operation of the automation system. The programming of an automation system differs from programming in other technical fields. For example, a first program that carries out an accounting procedure at the end of a month has a clear beginning and clear end and a short running time. All that is required is to make sure that it can be reactivated again one month later. If, however, a second program is required to control an automation system, e.g. an elevator, the program remains in operation as long as the elevator is running. The code length of the two named programs may be somewhat the same but the running time and parameters differ substantially. The second program is continuously repeated by the firmware of the automation system. In automation systems this is referred to as cyclical programming. The running time of the single cycle must be short because this corresponds approximately to the reaction time of the control system. When commissioning an automation system, operands are observed and also occasionally influenced, i.e. controlled, in that a user creates a suitable instruction that is executed by the automation system. It is thus possible to test the sensors and actuators of the system even before all the modules of the program have been completely programmed. When the program of the automation system is running, this observation should proceed with the minimum intervention in the running program.

The object of the invention is to simplify the creation of instructions in an automation system.

This object is achieved by a method for creating instructions in an automation system, by which method
operands, control values and instruction types associated with operands are created in the instructions, with said instructions being provided for execution by a firmware of the automation system,
the instructions can be parameterized by a user by input means of a programming device and
the programming device automatically specifies an execution moment and an application frequency of the instruction according to the operand and type of instruction and associates them with the instruction.

This object is achieved by a system for creation of instructions in an automation system, with
instructions being provided that are defined by operands, control values and types of instruction associated with the operands,
a firmware of the automation system is provided for execution of the instructions,
input means of a programming device for parameterizing the instructions by a user are provided and
the programming device is provided for automatic specification of an execution moment and application frequency of instructions relative to the operand and type of instruction and for association of the execution moment and application frequency to the instructions.

In systems already known, the decision as to when and how often an instruction initiated by a user for observing or controlling within an automation system is to be executed must be made by the user himself. The system in accordance with the invention makes this decision automatically in that it specifies the corresponding trigger settings relative to the operand and type of instruction and assigns them to the particular instruction. In accordance with the invention, the instruction is then passed by the programming device to the automation system and there it is executed at a specified execution moment during the execution of the cyclical program, so that the program need neither be interrupted nor its course disturbed by the execution of the instruction.

In an advantageous embodiment of the system in accordance with the invention, the program has one or more organization modules and other system modules. The organization modules are implemented by the firmware of the automation system in accordance with specific rules. These rules can be influenced in order to adapt the automation system to the task. The organization modules serve to implement operations that link operands to each other. Advantageously, there are organization modules that are implemented at fixed, parameterable time intervals. An organization module can call up other modules. The modules that are called up directly or indirectly by the organization module form an execution level. There is an organization module that is executed at the start of the automation system. There is also an organization module that is always started if no interval-controlled organization module is executed. This organization module, running in a free cycle, is used to implement the task. It is most frequently executed and therefore the automation system can react the fastest if the system detects no organization modules controlled by hardware events.

The various execution levels are prioritized by the firmware. The levels with the higher priority interrupt those with the lower priority. When all the modules of the higher level have been executed, those of the lower level are then completed.

A first system module forms a periphery on input values in a memory and a second system module forms output values from the memory to the periphery. Values detected by sensors are stored in the memory of the automation system in such a way that they can be accessed by the program. The outputs required by the program must again be passed from the memory to the actuators. For this purpose, the memory is divided into several areas, that are depicted in the programming language, i.e. inputs, outputs, markers, timers, counters, etc. The various areas are named according to their tasks. Because this is basically a memory, it is completely possible to write to an input or read an output.

In a further advantageous embodiment of the invention, the programming device automatically specifies an execution moment in each case and an application frequency of the instructions, in that operands and types of instruction that are stored in specified storage areas of the memory are linked on the basis of rules. Such storage areas are, for example, fields of a table that are provided by the user by using an input means to input operands, control values and types of instruction.

The invention is described in more detail using the exemplary embodiments in the following illustrations.

These are as follows:

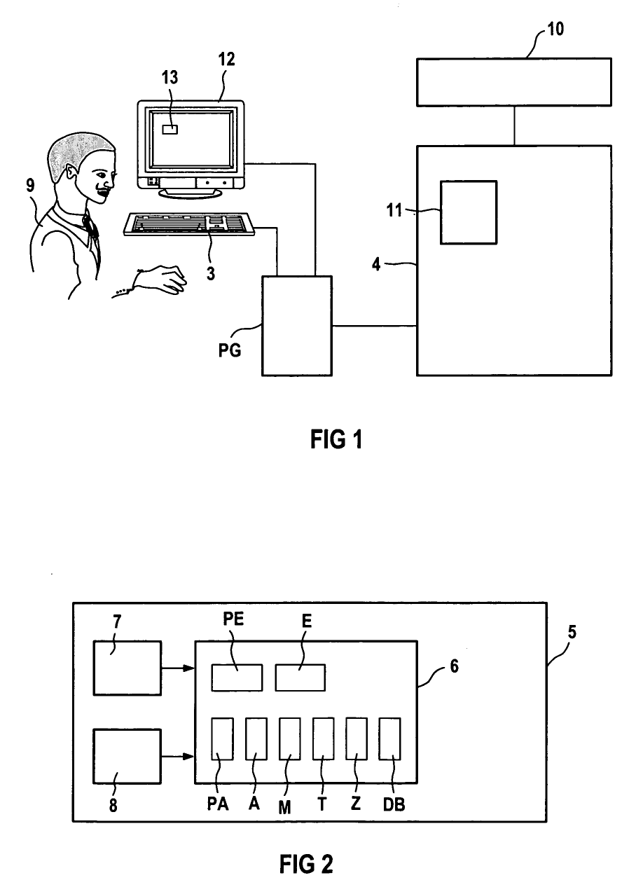

FIG. 1 A possible application scenario of the invention.

FIG. 2 A schematic representation of an instruction.

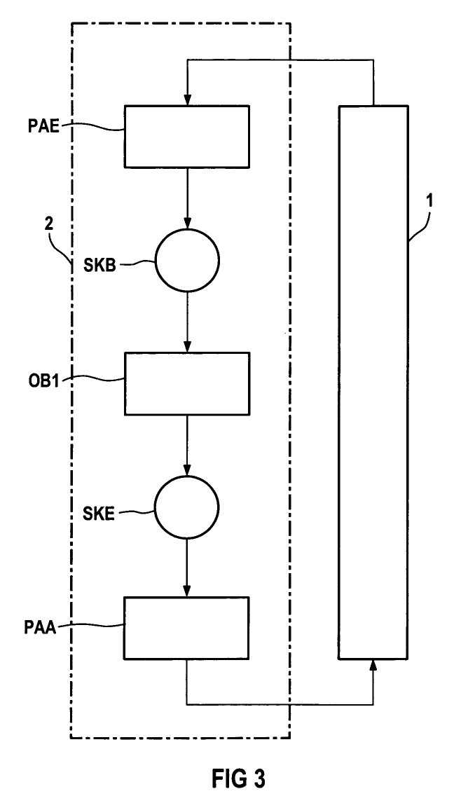

FIG. 3 The principle sequence of a program of an automation system.

FIG. 1 shows an automation system 4 with a memory 11 and a periphery 10. The automation system 4 is connected to a programming device PG. The programming device PG is connected to input means 3 and display means 12. Observed values 13 are shown in the display means 12. The system is used by one user 9.

FIG. 2 shows a schematic layout of an instruction 5. In the instruction 5, a type of instruction 8 (control, observe) and, if necessary, control values 7 are assigned to operands 6. The operands 6 are formed as input values E depicted in memory 11, input values PE received from the periphery 10 of the automation system 4 via a backplane bus, output values A depicted in memory 11, output values PA directly output to the periphery 10 via the backplane bus, markers M, timers T, counters Z and/or as data modules DB stored in memory 11.

FIG. 3 shows a firmware 1 of the automation system 4 that is executing a program 2. The program 2 contains a first system module PAE, a first execution moment SKB, an organization module OB1, a second execution moment SKE and a second system module PAA. The execution moments SKB, SKE are also designated system control points.

In the exemplary embodiment explained in the following using FIG. 1 to FIG. 3, the organization module OB1 contains the application program. The user 9 programs the completion of a control task in programming languages matched to the task. Depending on the language, this is reflected in different language structures. In the exemplary embodiment, a program 2 consists of modules and the modules consist of networks. The networks consist of operations that link operands 6 to each other. A network of this kind represents a logic operation. It corresponds to an instruction, e.g. a statement in Programming Language C or Pascal. A module corresponds to a procedure or function in C or Pascal. Modules can be mutually called up by each other. Under particular circumstances it can also be that the automation system 4 performs no module of the program 2. This special operating state (called STOP) occurs, for example, in the event of faults, e.g. a defect in a periphery 10, but it can also be necessary during the commissioning of the automation system 4 and requested by the programming device PG. During commissioning of an automation system 4, the user 9 may wish to observe, and occasionally also influence, i.e. control, operands 6. He can thus test the sensors and actuators himself before all the modules have been completely programmed. In a running operation of an automation system 4, this observation should, for example in contrast to the operation of operands 6 in an accounting system, take place with the minimum intervention in the running program 2. For this purpose, the programming device PG sends special instructions 5 to the automation system 4, that are to be executed by the firmware 1 without the cyclical operation being interrupted. With the aid of these instructions 5, it is now possible, for example, to observe outputs PA, A that are not connected to actuators, or to do this before the actuators are connected, or to simulate input values not supplied by the sensors.

The automation system 4 enters input values PE, E in a memory 11 and again applies output values PA, A from the memory 11 to the actuators. To depict the periphery 10 at input values PE, a first system module PAE is present in the automation system 4. Furthermore, a second system module PAA for depicting the outputs PA is present at periphery 10. The first system module PAE is implemented before the organization module OB1, and the second system module PAA after the organization module OB1 has been executed. The automation system 4 thus enters the values of sensors and controls with the first system module PAE and processes these in organization module OB1 with internal states for output values for actuators. The output values PA, A are applied to the actuators in the second system module PAA. The special instructions 5 for observation and control should now be implemented between the execution of the organization module OB1 and depiction of the periphery, so that they can also be effective. In FIG. 3, showing the cyclical sequence of the named modules, these two time points are shown as a first execution moment SKB and a second execution moment SKE. The suitable execution moment SKB, SKE is specified by the user 9 or automatically, in each case, when creating an instruction 5 for the observation or control of operands 6. The automation system 4 accepts the instruction 5 and implements it when the program 2 reaches the corresponding point of the execution moment SKB, SKE. The automation system 4 then continues with the normal program implementation. In this way, although the instruction 5 represents an intervention in the running system, the influence of the cycle time is minimal. In addition to execution of the instructions 5 at both named execution moments SKB, SKE, implementation at other points in the program sequence is also conceivable, e.g. at operating state transitions, at code addresses or implementation is also possible independent of any program points.

The cyclical operation of the program 2 of an automation system 4 poses a further question. How often should the instruction 5 be executed? After the instruction 5 has been executed, it is conceivable that the instruction 5 is deleted from the automation system 4, that it is blocked or that it is again executed at the next opportunity. Whichever strategy is to be preferred depends naturally on the instruction 5, the task of the automation system 4, i.e. on the permitted cycle time extension, and the capabilities of the communication link to the instruction issuer, the programming device PG. The specification of the execution moment SKB, SKE and the frequency of execution are called triggers. The trigger should be matched to the task.

### FIRST EXAMPLE

If the task is to control inputs PE, E, it is most appropriate to do this at the first execution moment SKB after it was formed by the first system module PAE and before it is used in the program 2. This instruction 5 should be executed in each cycle until the user 9 no longer requires the instruction 5.

### SECOND EXAMPLE

If the task is to control outputs PA, A in order to override a program that is not having the effect it should, then it is best for this to take place at the second execution moment SKE. Otherwise, the program 2 can again overwrite the memory position of the output PA, A at any time. This instruction 5 should be executed in each cycle until the user 9 no longer requires the instruction 5.

### THIRD EXAMPLE

If the task is observation, it is not appropriate to do this in each cycle because the communication possibilities with the programming device PG are limited. If the automation system 4 supplies more data than can be transmitted and/or processed, a flow control must be specified. If the trigger has been reached, the instruction 5 is blocked on the automation system 4 until the programming device PG has displayed the observed values 13 on the display means 12 and again enabled the instruction 5.

### FOURTH EXAMPLE

If the task is to observe or control when the automation system 4 is in the STOP mode, the execution moments SKB, SKE cannot be used because they are not reached. In this case, a single execution independent of the program execution is appropriate (Trigger: Immediate). This enables markers M to be initialized and/or the periphery 10 to be tested.

### FIFTH EXAMPLE

The task is for the automation system 4 to realize an automatic state device. The state is stored in a marker M, i.e. in a part of the memory 11. For test purposes, it is now desired to place the automatic device in a specific state without the reactions of the automatic device influencing the inputs PE, E. In this case, it is sufficient to execute the control instruction for the marker M just once at the first execution moment SKB. Immediately the trigger is reached, the instruction 5 may be deleted.

As can be seen from the examples, it is difficult for a user 9 to determine how the trigger of an instruction 5 is to be set. They show that the triggers should be selected relative to the operands 6 and type of instruction 8. The operands 6 to be observed or the operands 6 to be controlled and their control values 7 are combined in one instruction 5. The number of operands 6 in one instruction 5 and the number of instructions 5 for an automation system naturally depends on the automation system 4 and on the programming device PG and its communication capabilities. These are subject to limitations in each case. Generally there is no remedy with regard to these limitations. All that is possible is to utilize the available possibilities to best advantage. The various triggers serve for this purpose. For each possibility there is a useful application. An inexperienced user 9 cannot easily see which trigger he should use in what case. If several instructions 5 are set to one trigger, the sequence in which these are executed is not ensured. The automation system 4 could combine the operands 6 of the instructions 5 set at one trigger point to form one instruction 5, which would lead to a substantial expenditure in the automation system 4. This could lead to overlaps in the control values 7 that would then have to be processed according to special rules.

The method and system proposed here automatically select a suitable trigger. The application in the exemplary embodiment has two “faces”. The simple user 9 is no longer afforded the possibility of setting the precise trigger conditions; these are preset by the programming device PG. The user 9 can input the operands 6 and the control values 7 and can stop and start the instructions 5. All the existing facilities are available to the experienced user 9 and in addition he can select the method performed for the simple user 9, e.g. as “Trigger: Automatic”. The user 9 partially completes a table with at least five columns. A table of this kind is shown in the following example.

| Operand | Observe? | Observed value | Control? | Control value |
|---|---|---|---|---|
| e1.0 | Yes | True | Yes | True |
| a4.3 | Yes | False | Yes | False |
| mw6 | Yes | 22 | No | |
| eb4 | No | | No | |
| aw4 | Yes | 88 | No | |

In the example, the first column contains the operand 6. The second column shows whether the operand 6 is to be observed. The third column contains the observed value 13. This column is, of course, not completed by the user 9. The fourth column shows whether the operand 6 is to be controlled, and the fifth column finally shows the associated control value 7. How instructions 5 for the automation system 4 are created from this table is described in the following. As described in the aforementioned second example, it is appropriate to control outputs PA, A at the second execution moment SKE. This ensures that the control values 7 are also actually applied at the periphery 10. It is, however, not appropriate to control inputs PE, E at the second execution moment SKE because these values would be immediately overwritten by the first system module PAE. Two control instructions are created from the example table. The first instruction contains all inputs PE, E and is assigned the first execution moment SKB. The second instruction contains all the other operands 6 and is assigned the second execution moment SKE. Both instructions are executed in each cycle of the program 2. If one of the two instructions is empty, e.g. because the table contains no input PE, E in the first column, this instruction is not installed in the automation system 4. Because the outputs PA, A are activated at the second execution moment SKE, it is appropriate to observe them at a first execution moment SKB. This ensures that the controlled values are also again visible. Otherwise the automation system 4 would have to be able to provide a sequence in the automation system 4 for the processing of instructions 5. This additional requirement for the automation system 4 is thus avoided. For this reason, it is also appropriate to observe the inputs PE, E at the second execution moment SKE. In addition, two observation instructions are generated from the example table: A third instruction contains all inputs PE, E and is assigned the second execution moment SKE. A fourth instruction contains all other operands 6 and is assigned the first execution moment SKB. The two latter instructions are blocked after each trigger until they are again jointly enabled by the programming device PG. This applies as long as the automation system 4 goes to the STOP mode. In this case, the execution moments SKB, SKE are no longer reached, which means that no more new values are displayed. Now, of course, the programming device PG sends, at fixed time intervals, an observation instruction without a special execution moment, containing all the operands 6 to be observed, to the automation system 4. This places no burden on the automation system 4 because no cycle is performed during the STOP mode. The control instructions are not influenced by the STOP mode. If the user 9 wishes to exert control in the STOP mode, he must change to the mode for experienced users. In that mode he can continue to observe the operands 6 by using the “Trigger: Automatic” and use the “Trigger: Immediate” for the operands 6 to be controlled.

The table showing the exemplary embodiment is thus divided into four different instructions 5. In the third instruction, the input values E depicted in the memory 11 and input values PE received via a backplane bus from the periphery 10 of the automation system 4 are observed at the second execution moment SKE. In the first instruction the named input values PE, E are controlled at the first execution moment SKB, i.e. control values 7 are assigned to them. In the fourth instruction, operands 6 are observed at the first execution moment SKB. These operands 6 are, for example, output values A depicted in memory 11, output values PA output directly via the backplane bus to the periphery 10, markers M, timers T, counters Z and data modules DB stored in the memory 11. The same operands 6, with the exception of the timer T, can be controlled in the second instruction at the second execution moment SKE. Empty instructions are not installed. An empty instruction is one in which the information necessary regarding operands 6, type of instruction 8 and/or control value 7 is absent. In the STOP mode, all operands 6 in an instruction 5 with “Trigger: Immediate” are observed at a fixed time interval.

The proposed system and method makes it easier to specify conditions for observation and control of operands 6. The user 9 is thus relieved of things which in many cases are of no interest to him. In addition, a set of rules is formed enabling appropriate decisions regarding the selection trigger conditions to be made. The set of rules automatically generates the decisions from inputs of a user 9 that the user 9 inputs to the system, e.g. in the form of table inputs.

To sum up, the invention thus provides a method and a system for the creation of instructions 5 in an automation system 4, that is used especially to complete a control task or to regulate a process. The creation of instructions 5 is simplified by defining operands 6, control values 7 and instruction types 8 associated with the operands 6, in the instructions 5, with the instructions 5 being provided for execution by a firmware 1 of the automation system 4. The instructions 5 can be parameterized by a user 9 by input means 3 of a programming device PG and the programming device PG automatically specifies an execution moment SKB, SKE and an application frequency for instructions 5 according to the operand 6 and type of instruction 8 and assigns them to the instructions 5.

1. A method for creating instructions in an automation system, comprising:
defining operands, control values, and types of instructions associated with the operands in instructions, whereby the instructions are provided for execution by a firmware of the automation system;
parameterizing the instructions by a user by input of a programming device and
automatically specifying by the programming device an execution moment and an application frequency of the instructions according to the operands and type of instruction; and
assigning the execution moment and the application frequency of the instructions to the instructions by the programming device.

2. A method in accordance with claim 1, further comprising:
executing the instructions, the executing comprising:
cyclically-repeated executing a program by the firmware of the automation system;
passing the instructions by the programming device to the automation system; and
executing the instructions by the firmware immediately after the program arrives at the execution moment assigned to the particular instruction, wherein the cyclical execution of the program not being ended.

3. A method in accordance with claim 2, wherein the program containing at least one organization module and system modules, with the organization module provided for execution of operations that link operands to each other, with a first system module provided for depicting a periphery on input values in a memory and a second system module provided for depicting output values from the memory on the periphery.

4. A method in accordance with claim 1, wherein the operands are designed as input values and output values, wherein the program accessing the input values and creating the output values by combining the input values.

5. A method in accordance with claim 1, wherein a first execution moment of the instructions lies between the execution of the first system module and the execution of the organization module, and a second execution moment of the instructions lies between the execution of the organization module and the execution of the second system module.

6. A method in accordance with claim 5, wherein a second type of instruction contains an observation of operands, with observed values of operands being displayed to the user by a display device of the programming device, with input values being observed at the second execution moment, with output values being observed at the first execution moment and instructions of the first type of instruction not being executed on the automation system as long as the programming device blocks the instruction.

7. A method in accordance with claim 5, wherein a second type of instruction contains a control of operands, with a control value being assigned for controlling an operand, with input values being controlled at a first execution moment, with output values being controlled at a second execution moment and instructions of the second type of instruction being executed in each cycle if the instructions contain operands.

8. A method in accordance with claim 1, wherein the program is not cyclically executed and the execution of the instructions of the first and/or second type of instruction is activated by the program device.

9. A method in accordance with claim 1, wherein the automation system realizes an automatic state device, with a state being stored in an operand formed as a marker in the memory and with the second type of marker being controlled at the second execution moment by the once-only execution of an instruction and the automatic device being thus set to a specific state.

10. A method in accordance with claim 1, wherein the input means to input operands, the control values and the types of instruction are provided in fields of a table and the instructions are automatically generated from the fields of the table.

11. A method in accordance with claim 1, wherein the operands, the control values and the types of instruction are automatically determined from a hardware configuration or cross-reference list and the instructions are automatically created from the data determined in this way.

12. A method in accordance with claim 1, wherein the user is given a facility of a choice between an automatic and manual specification of the particular execution moment and the particular application frequency of instructions.

13. A system for creating instructions in an automation system, comprising:
instructions defined by operands, control values, and types of instruction assigned to the operands;
a firmware operatively associated with the automation system for execution of the instructions;
an input device for parameterizing the instructions; and
a programming device for the automatic specification of an execution moment and an application frequency of the instructions relative to an operand and type of instruction and for assignment of the execution moment and application frequency to the instructions.

14. A system in accordance with claim 13, for execution of instructions comprising: a program cyclically-repeated by the firmware of the automation system; the programming device adapted for passing on the instructions to the automation system; and the firmware adapted for execution of instructions at the execution moment assigned to the particular instruction, wherein an ending of the cyclical execution of the program not being provided.

15. A system in accordance with claim 13, wherein the program contains at least one organization module and system modules, with the organization module being provided for the execution of operations that link operands to each other, with a first system module being provided for the depiction of a periphery on input values in a memory and a second system module being provided for the depiction of output values from the memory on the periphery.

16. A system in accordance with claim 13, wherein the operands are designed as input values and output values, with the program being provided for access to the input values and for creation of output values by combining input values.

17. A system in accordance with claim 13, wherein a first execution moment of instructions lies between the execution of the first system module and the execution of the organization module and that a second execution moment of the instructions lies between the execution of the organization module and the execution of the second system module.

18. A system in accordance with claim 17, wherein a first type of instruction contains an observation of operands, with a display means of the programming device being provided for the display of observed values of operands, with an observation of input values at the second execution moment and an observation of the output values at the first execution moment being provided and the programming device being provided for blocking the execution on the automation system of instructions of the first type of instruction.

19. A system in accordance with claim 17, wherein a second type of instruction contains a control of operands, with a control value being provided for assignment to an operand, with a control of input values at the first execution moment and a control of the output values at the second execution moment being provided and with an execution of the instructions of the second type of instruction, that contain operands, being provided in each cycle.

20. A system in accordance with claim 13, wherein that where there is a non-cyclic repeated execution of the program, the programming device is provided for initiation of the execution of instructions of the first and/or second type of instruction.

21. A system in accordance with claim 13, wherein the automation system realizes an automatic state device, with an operand formed as a marker being provided for storage of a state in the memory and with a once-only executed instruction of the second type being provided for the control of the marker at the second execution moment, and thus for placing the automatic device in a specific state.

22. A system in accordance with claim 13, wherein the input means for the input of operands, the control values and the types of instruction are provided in fields of a table and the system is provided for automatic generation of instructions from fields of the table.

23. A system in accordance with claim 13, wherein the programming device is provided for automatic determination of operands, of control values and types of instruction from a hardware configuration or a cross-reference list, and for automatic generation of the instructions from the data determined in this way.

24. A system in accordance with claim 13, wherein a facility of a choice between an automatic and manual specification of the particular execution moment and the particular application frequency of the instructions is provided for the user.
